(19) United States
(12) Patent Application Publication
(10) Pub. No.: US 2026/0111271 A1
(43) Pub. Date: Apr. 23, 2026

(54) PROCESSING NETWORK COMMUNICATON FOR A DATA PROCESSING SYSTEM USING A MANAGEMENT CONTROLLER

(71) Applicant: Dell Products L.P., Round Rock, TX (US)

(72) Inventors: GOKUL THIRUCHENGODE VAJRAVEL, Bangalore (IN); ABEYE TESHOME, Austin, TX (US); VINODKUMAR VASUDEV OTTAR, McKinney, TX (US); BASSEM EL-AZZAMI, Austin, TX (US); MOHIT ARORA, Frisco, TX (US); RICHARD M. TONRY, Georgetown, TX (US); ADOLFO SANDOR MONTERO, Pflugerville, TX (US); LUIS ANTONIO VALENCIA REYES, Waxahachie, TX (US); RAJARAVI CHANDRA KOLLARAPU, Allen, TX (US)

(21) Appl. No.: 18/919,997

(22) Filed: Oct. 18, 2024

(51) Int. Cl. G06F 9/50; H04L 43/08; H04L 45/745

(52) U.S. Cl. CPC G06F 9/5027; H04L 43/08; H04L 45/745

(57) ABSTRACT

Methods and systems for processing network communications for operation of a data processing system are disclosed. The method may include redirecting, via a network module hosted by the data processing system, the network communications received from a management system to a management controller hosted by the data processing system. The management controller may screen the network communications to identify an action set to be performed. The management controller may perform a command indicated by the network communications to place the hardware resources in an updated operating state, and/or direct the network communications to the hardware resources to be performed.

### FIELD

Embodiments disclosed herein relate generally to processing network communications for operation of a data processing system. More particularly, embodiments disclosed herein relate to processing network communications for operation of a data processing system by redirecting communications from a management system to a management controller of the data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for processing network communications for operation of a data processing system. The data processing system may provide computer-implemented services to any type and number of other devices and/or users of the data processing system. The computer-implemented services may include any quantity and type of such services.

While providing the computer-implemented services, the data processing system may require modifications to operation of hardware resources hosted by the data processing system. To modify operation of the data processing system, a management controller of the data processing system may be utilized. The management controller may operate independently from the hardware resources and may be distinct from the hardware resources. Additionally, the data processing system may be adapted to separately advertise network endpoints for the management controller and the hardware resources. Therefore, the management controller may provide management functionalities for the data processing system regardless of a status of the hardware resources.

To provide the management functionalities, the management controller and/or the hardware resources may receive information from and/or provide information to a management system (e.g., a server system, a second data processing system, etc.) via network communications. For example, the management system may transmit a message regarding a management service request directed to the data processing system based on a request prompted by the hardware resources and/or the management controller.

Because the management system may not distinguish the management functionalities provided by the management controller and the hardware resources, network communications directed to the hardware resources may not be processed by the management controller. For example, the management system may register one network addressable endpoint for communication with the data processing system, and subsequently a portion of the communication may not be processed by the data processing system if the hardware resources are inoperable.

To improve a likelihood that management functionalities may be performed by the data processing system based on communications from a management system, the communications may be redirected, via a network module of the data processing system, to a management controller so that the management controller may screen the communications.

To do so, a consolidated management infrastructure may be established between the management system and management components (e.g., the management controller and the hardware resources) of the data processing system. The consolidated management infrastructure may be established, for example, by registering a network addressable endpoint (e.g., a media access control address of a network interface) of the hardware resources with the management system, and reconfiguring a traffic flow configuration so that communications from the management system directed to the hardware resources may be redirected to the management controller by the network module.

When the management system sends a management service request to hardware resources of the data processing system, the network module may obtain the management service request and redirect the management service request to the management controller. The management controller may screen the management service request to identify an action set to perform.

For example, the management controller may identify a type of command indicated by the management service request, and determine whether the command is to be performed by the hardware resources. Additionally, the management controller may identify whether the hardware resources is in an operable state to perform the command (e.g., the operating system is available). To perform the action set to update operation of the data processing system, the management controller may perform the command, direct the management service request to the hardware resources to perform, and/or queue the management service request to direct to the hardware resources at a future time (e.g., when the operating system is available).

Thus, embodiments disclosed herein may provide an improved method for processing network communications for operation of a data processing system by redirecting network communications from a management system and directed to hardware resources of the data processing system to a management controller of the data processing system. By doing so, an ability of the management controller to manage operation of the data processing system may be improved.

In an embodiment, a method for processing network communications for operation of a data processing system is provided. The method may include: (i) obtaining by a management controller of the data processing system, a management service request (a) from a management system tasked with remotely managing operation of the data processing system, (b) directed to hardware resources of the data processing system, and (c) redirected, by a network module of the data processing system, to the management controller; (ii) screening, by the management controller, the management service request to identify an action set to perform based on the management service request; (iii) initiating, by the management controller, performance of the action set to place the hardware resources in an updated operating state; and (iv) providing, by the hardware resources, computer-implemented services while operating in the updated operating state.

The method may also include: prior to obtaining the management service request by the management controller: (i) obtaining, by the network module, the management service request; (ii) performing, by the network module, a lookup based on control information of the management service request to obtain a lookup result, the control information comprising a source network address and a destination network address; (iii) making a determination regarding whether the lookup result meets criteria; and (iv) in an instance where the lookup result meets the criteria: (a) redirecting, by the network module, the management service request to the management controller.

The criteria may include: (i) a source network address being a network addressable endpoint of the management system; and (ii) a destination network address being a network addressable endpoint of the hardware resources.

The method may also include: prior to obtaining the management service request: (i) establishing a consolidated management infrastructure between the management system and management components of the data processing system, the management components comprising the management controller and the hardware resources.

Establishing the consolidated management infrastructure may include: (i) providing, by the hardware resources, a network addressable endpoint of the hardware resources to the management system; (ii) obtaining, by a network module of the data processing system, a connection notification from the management system indicating a connection policy; and (iii) reconfiguring, by the network module, a traffic flow configuration based on the connection policy so that communication directed to the hardware resources are redirected to the management controller.

The network addressable endpoint may include a media access control (MAC) address.

The connection policy may include one MAC address from a group consisting of: (i) the network addressable endpoint of the hardware resources; and (ii) a preferred MAC address provided by the management system.

Screening the management service request may include: (i) identifying a type of command indicated by the management service request; and (ii) making a determination regarding whether the command is to be performed by the hardware resources.

The action set may include at least one action from a group of actions consisting of: (i) performing, by the management controller, the command; (ii) identifying an availability of an operating system hosted by the hardware resources; (iii) in a first instance of the identifying where the operating system is available: (a) directing the management service request to the hardware resources; and (iv) in a second instance of the identifying where the operating system is not available: (a) queuing the management service request to be directed to the hardware resources at a future time.

The data processing system may include hardware resources and a network module adapted to separately advertise network endpoints for the management controller and the hardware resources, the network endpoints being usable by a remote entity to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

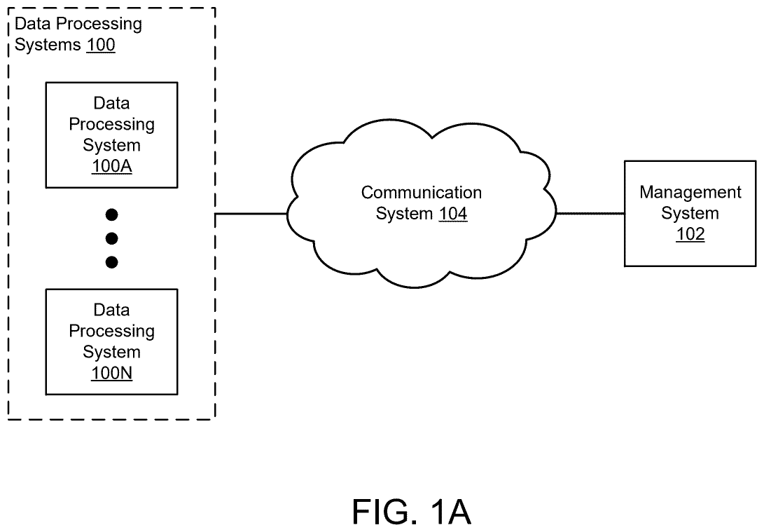

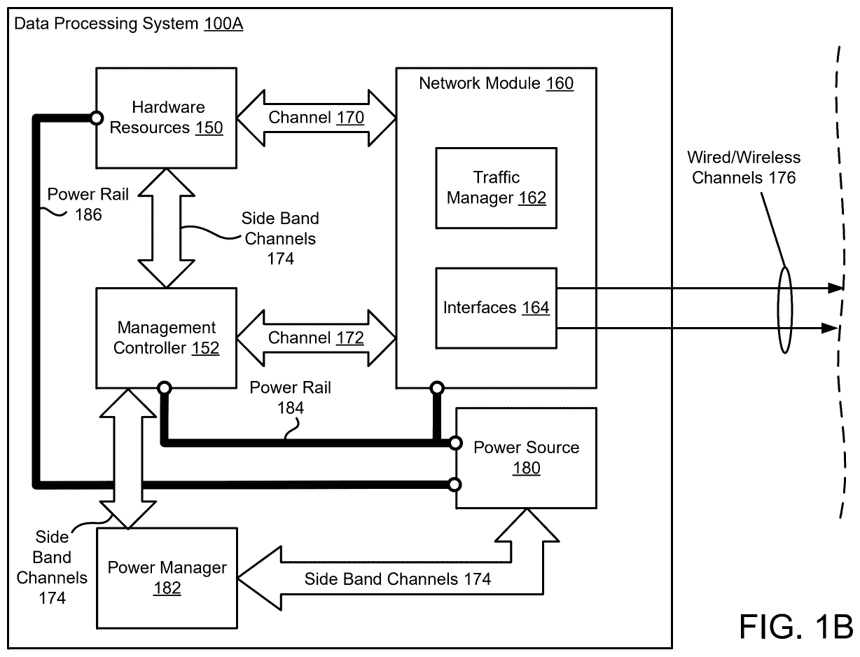

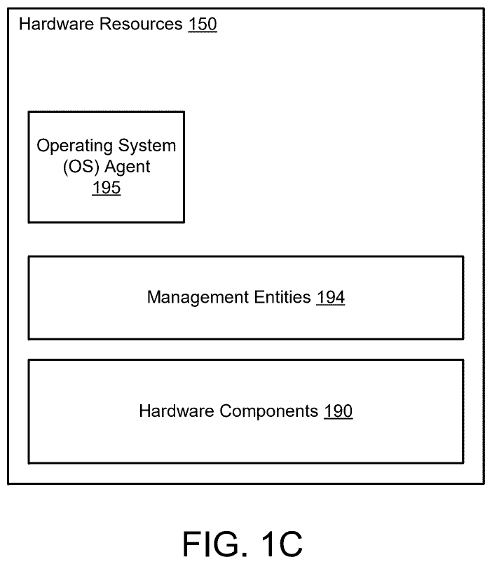

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIGS. 1B-1C for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

To provide the computer-implemented services, the data processing system may operate in a manner conducive to, for example, execution of applications that provide the computer-implemented services. To provide the computer-implemented services, the applications may utilize certain hardware resources and/or software components hosted by the hardware resources. Operation of the applications and/or hardware resources may be modified to provide updated computer-implemented services.

To modify operation of the data processing system, a management controller of the data processing system may be utilized. The management controller may operate independently from the hardware resources and may be distinct from the hardware resources. Additionally, the data processing system may be adapted to separately advertise network endpoints for the management controller and the hardware resources. Therefore, the management controller may provide management functionalities for the data processing system regardless of a status of the hardware resources.

To provide the management functionalities, the management controller and/or the hardware resources may receive information from and/or provide information to a management system (e.g., a server system, a second data processing system, etc.) via network communications. For example, the management system may transmit a message regarding a management service request directed to the data processing system based on a request prompted by the hardware resources and/or the management controller.

However, an ability of the management controller to provide management functionalities for the data processing system may be impacted when network communications from the management system are directed to a network addressable endpoint of the hardware resources. For example, the management system may register one network addressable endpoint for communication with the data processing system, and subsequently may not distinguish between management functionalities provided by the management controller and the hardware resources.

In general, embodiments disclosed herein may provide methods, systems, and/or devices for processing network communication for operation of a data processing system. To improve a likelihood that management functionalities may be performed by the data processing system based on communications from a management system, the communications may be redirected, via a network module of the data processing system, to a management controller so that the management controller may screen the communications.

To do so, a consolidated management infrastructure may be established between the management system and management components (e.g., the management controller and the hardware resources) of the data processing system. The consolidated management infrastructure may be established, for example, by registering a network addressable endpoint (e.g., a media access control address of a network interface) of the hardware resources with the management system, and reconfiguring a traffic flow configuration so that communications from the management system directed to the hardware resources may be redirected to the management controller by the network module.

When the management system sends a management service request to hardware resources of the data processing system, the network module may obtain the management service request and redirect the management service request to the management controller. The management controller may screen the management service request to identify an action set to perform.

For example, the management controller may identify a type of command indicated by the management service request, and determine whether the command is to be performed by the hardware resources. Additionally, the management controller may identify whether the hardware resources is in an operable state to perform the command (e.g., the operating system is available). To perform the action set to update operation of the data processing system, the management controller may perform the command, direct the management service request to the hardware resources to perform, and/or queue the management service request to direct to the hardware resources at a future time (e.g., when the operating system is available).

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain network communications from management system 102. For example, the network communications may include a management service request directed to a network addressable endpoint of hardware resources of data processing system 100A. The management service request may be obtained by a network module of data processing system 100A based on the network addressable endpoint of the hardware resources.

Management system 102 may, as discussed above, provide remote management services. To provide the remote management services, management system 102 may interact with data processing systems 100 to provide information and/or resources relevant to operation of data processing systems 100. For example, management system 102 may send commands to be executed to update a state of at least one data processing system of data processing systems 100, files (e.g., disc images, repair files, etc.), updates to firmware and/or drivers used by data processing systems 100, and/or any other information regarding the at least one data processing system of data processing systems 100.

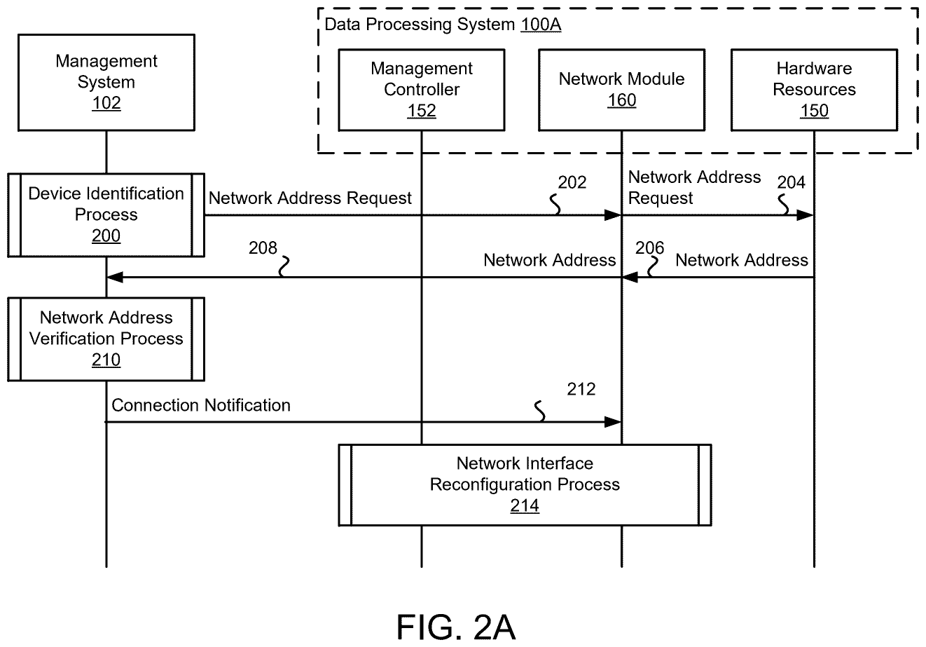

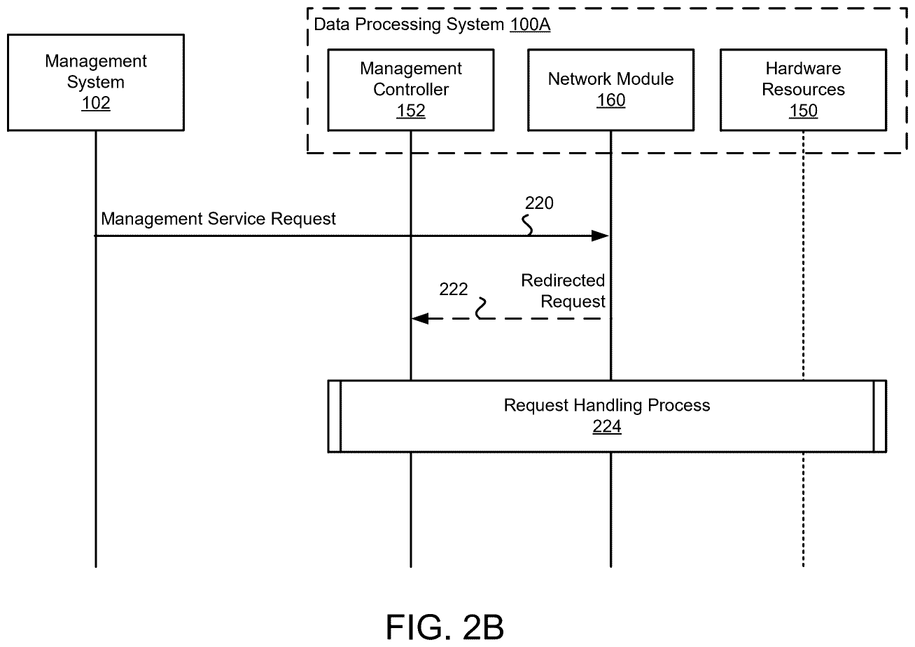

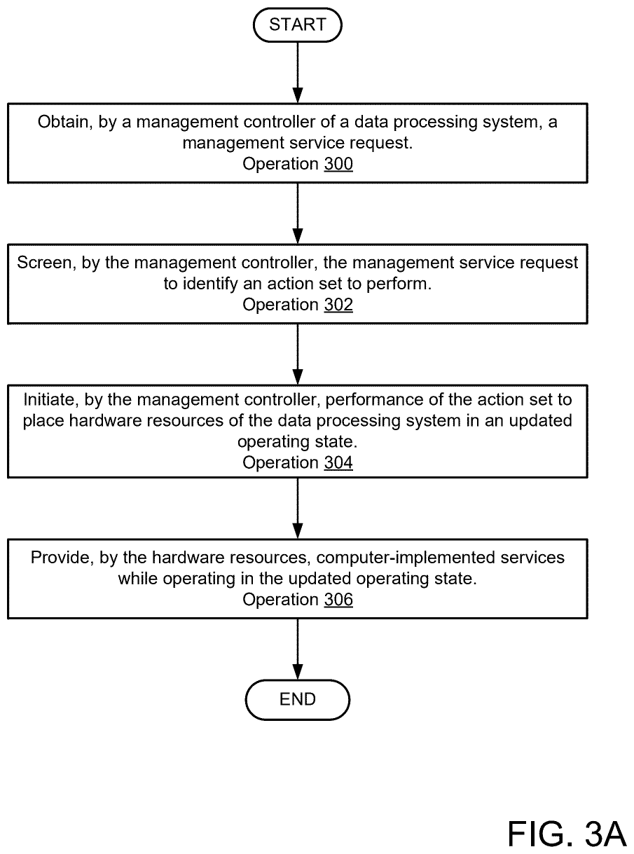

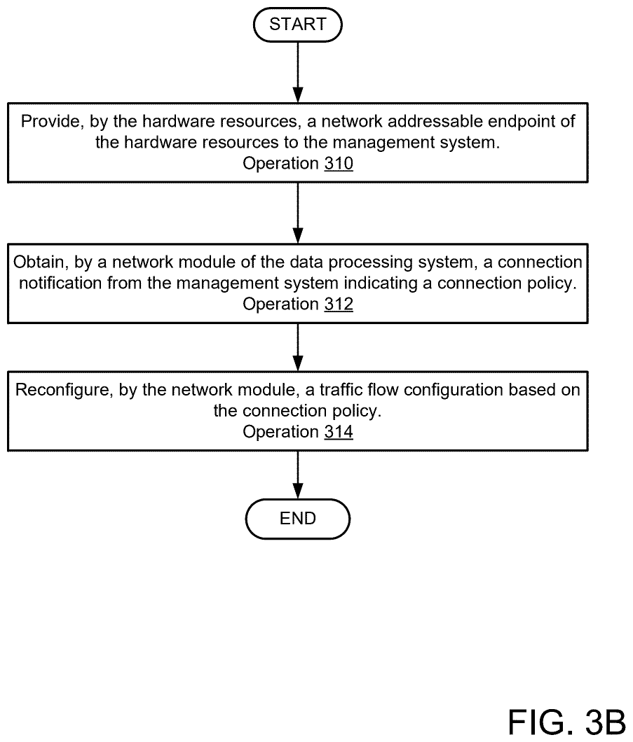

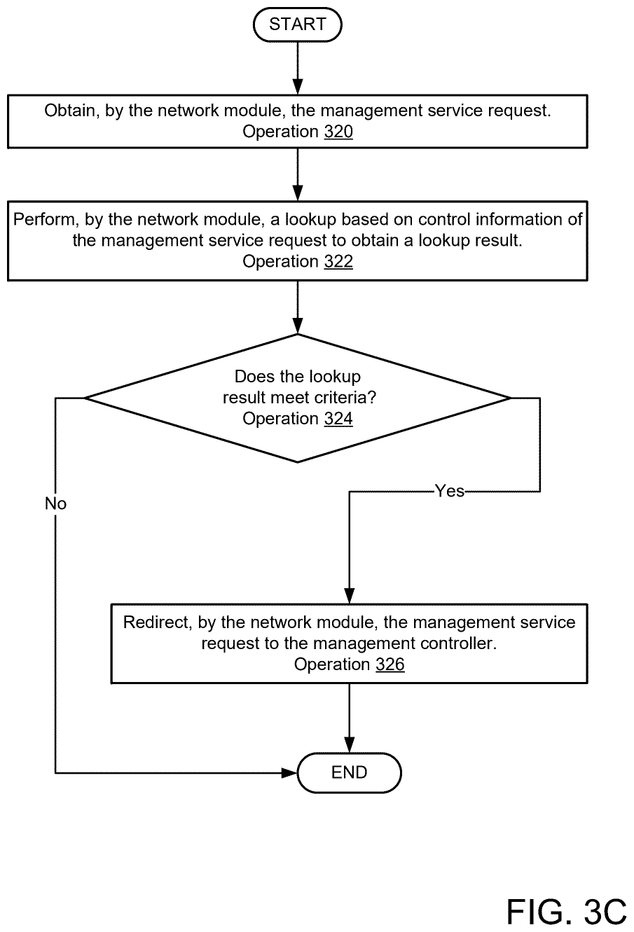

While providing their functionality, any of data processing systems 100 and/or management system 102 may provide all or a portion of the methods shown in FIGS. 2A-3B.

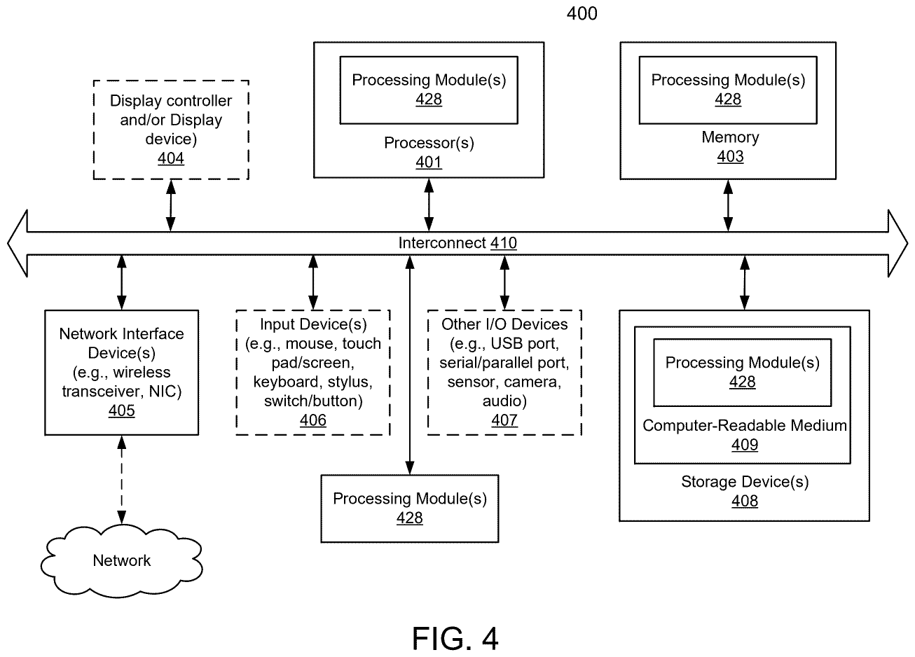

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to server systems 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may process network communications for a data processing system of data processing systems 100 by reconfiguring a flow of network communication obtained from a management system to be screened by a management controller of the data processing system. By doing so, the management controller may identify an action set to perform to update operation of the data processing system.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

Hardware resources 150 may communicate with management system 102 that may be tasked with managing operation of data processing system 100A using (at least indirectly) the network stack. For example, based on an operating state of hardware resources 150 and/or software entities hosted by hardware resources 150, a request may be prompted to management system 102.

However, the communications between management system 102 and hardware resources 150 may be limited when the operating system is not in an operable state based on a power state of hardware resources 150. For example, when hardware resources 150 are performing a booting process, operation of the operating system may not be initiated, applications may not be executable, and/or hardware resources 150 may be compromised.

To improve a likelihood that data processing system 100A may obtain remote management services regardless of an operating state of hardware resources 150, communication with remote entities may be managed by a management controller of data processing system 100A. To manage the communication, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to process network communication from management system 102, management controller 152 may (i) obtain a management service request from management system 102, (ii) screen the management service request to identify an action set to perform, (iii) perform the action set to place the hardware resources in an update operating state, and/or any other processes.

Additionally, management controller 152 may obtain information regarding an operating state of hardware resources 150. Based on the information and the management service request, management controller 152 may perform a command indicated by the management service request, direct the management service request to hardware resources 150 to be performed, and/or queue the management service request to direct to the hardware resources at a future time. For example, if hardware resources 150 is in a powered off state and the management service request indicates a remote request to power on hardware resources 150 (e.g., wake on local area network request), management controller 152 may invoke a command to power on hardware resources 150.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, communication transmitted from management system 102 may be received by network module 160. Network module 160 may analyze the communication to identify control information (e.g., header, payload, etc.) of the communication, perform a lookup based on the control information, identify whether the communication is directed to a network addressable endpoint (e.g., a media access control address) of hardware resources 150, and/or redirect the communication to management controller 152.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3C.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host management entities 194. Management entities 194 may include, for example, drivers, operating systems, and/or other entities that facilitate operation of applications by facilitating use of hardware components 190. Hardware components 190 may include processors, memory modules, storage devices, and/or other types of hardware components usable to provide computer-implemented services.

To facilitate cooperation between management controller 152 and hardware resources 150, hardware resources 150 may host operating system agent 195. Operating system agent 195 may be independent from operating system environments, and may facilitate communication with and performance of instructions by management controller 152.

For example, operating system agent 195 may include functionality to (i) monitor various operating system environments, and components therein, (ii) identify a status of an operating system hosted by hardware resources 150, (iii) identify operating states (e.g., nominal, stalled, in error of various levels of severity), (iv) obtain information regarding the states of the environments such as, for example, content of memory, processors, logs of operation of various software and/or hardware components, and/or perform other types of management actions through which information regarding the operation of entities hosted by hardware components 190 may be collected.

While illustrated in FIG. 1C with a limited number of specific components, a system may include additional, fewer, and/or different components without departing from embodiments disclosed herein.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 102, 152, etc.), located towards the top of each figure. Lines descend from these shapes. Processes performed by the components of the system are illustrated using a second set of shapes (e.g., 200, 206, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 208. However, it will be appreciated that the processes and interactions may be performed in different orders, any may be omitted, and other processes or interactions may be performed without departing from embodiments disclosed herein.

The lines descending from some of the first set of shapes (e.g., 150) is drawn in dashing to indicate, for example, that at least a portion of the corresponding components may not be (i) operable, (ii) powered on, (iii) present in the system, and/or (iv) not participating in operation of the system for other reasons.

Turning to FIG. 2A, a first interaction diagram in accordance with an embodiment is shown. The first interaction diagram may illustrate processes and interactions that may occur during establishing of a consolidated management infrastructure.

To establish the consolidated management infrastructure, device identification process 200 may be performed. During device identification process 200, data processing system 100A may be identified to receive remote management services from management system 102. For example, to identify data processing system 100A, management system 102 and/or an entity tasked with operating management system 102 (e.g., an administrator) may: (i) obtain a management schema that may define one or more data processing systems that may be managed using management system 102, (ii) identifying that a network connection is to be established with the one or more data processing systems, and/or any other processes.

At interaction 202, a network address request may be provided to network module 160 by management system 102. To generate and provide the network address request to network module 160, management system 102 may (i) perform a lookup on a cached table (e.g., an address resolution protocol table) to obtain a lookup result relevant to data processing system 100A, (ii) transmit the network address request via a message (e.g., a network packet) to a network addressable endpoint of network module 160, (iii) broadcasting a request message (e.g., across a local area network) that may be received by at least network module 160, and/or performing any other actions.

At interaction 204, the network address request may be provided to hardware resources 150. To generate and provide the network address request to hardware resources 150, network module 160 may: (i) redirect the address request to hardware resources, (ii) transmit the network address request via a message to a network addressable endpoint of hardware resources 150, (ii) store the network address request in a storage with subsequent retrieval by hardware resources 150, and/or perform any other actions.

At interaction 206, a network address may be provided to network module 160 by hardware resources 150. To generate and provide the network address to network module 160, hardware resources 150 may (i) store the network address in a storage with subsequent retrieval by network module 160, (ii) transmit the network address via a message to network module 160, (iii) provide access to information related to network interfaces used by a network stack of hardware resources 150, and/or any other processes.

At interaction 208, the network address may be provided to management system 102 by network module 160. To provide the network address to management system 102, network module 160 may (i) transmit a response message (e.g., including a media access control address, an internet protocol address, etc.) to management system 102, (ii) store the network data in a storage with subsequent retrieval by management system 102, and/or any other processes.

To verify a device registration compatibility between management system 102 and data processing system 100A, network address verification process 210 may be performed. During network address verification process 210, management system 102 may identify whether the network address (obtained at interaction 208) can be registered, and attempt to register the network address. For example, to identify whether the network address of hardware resources 150 can be registered, management system 102 may (i) compare the network address to a policy indicated by the management schema, (ii) compare the network address to an access control list hosted by management system 102, and/or perform any other actions. To attempt to register the network address, management system 102 may (i) store the network address in the cached table hosted by management system 102, (ii) assign the network address to a management group, and/or perform any other actions. By attempting to register the network address during network address verification process 210, management system 102 may generate a connection notification.

At interaction 212, the connection notification may be provided to network module 160. To generate and provide the connection notification to network module 160, management system 102 may (i) generate a registration confirmation indicating that the network endpoint of hardware resources 150 is registered to management system 102, (ii) generate a preferred network address for data processing system 100A to use based on the policy of the management schema hosted by management system 102, (iii) transmit a notification (e.g., the registration confirmation or the preferred network address) to network module 160 via a message, and/or any other processes. By providing the connection notification to network module 160, network module 160 may modify a traffic flow configuration to process communications from management system 102.

To modify a traffic flow configuration, network interface reconfiguration process 214 may be performed. During network interface reconfiguration process 214, a configuration may be established so that communication directed to hardware resources 150 may be redirected to management controller 152. For example, to establish the configuration, (i) a communication forwarding policy that may define a network address of management controller 152 to receive redirected communications may be implemented by network module 160, (ii) one or more network addresses of interfaces hosted by network module 160 may be modified (e.g., for a certain session via spoofing and based on a preferred network address provided by management system 102), (iii) information regarding the connection notification (obtained from management system 102) and/or the communication forwarding policy may be cached in a storage hosted by management controller 152, (iv) connection configurations may be applied to establish a network connection between data processing system 100A and management system 102 (e.g., by resetting the one or more interfaces hosted by network module 160), and/or any other processes.

Thus, using processes and interactions shown in FIG. 2A, a consolidated management infrastructure may be established between a management system and a data processing system. Using the consolidated management infrastructure, network communications obtained from the management system may be processed by at least a management controller of the data processing system. By doing so, a quality and/or availability of computer-implemented services provided by the data processing system may be improved.

Turning to FIG. 2B, a second interaction diagram in accordance with an embodiment is shown. The second interaction diagram may illustrate processes and interactions that may occur during processing of a management service request directed to a data processing system from a management system.

The lines descending from some of the first set of shapes (e.g., 150) is drawn in dashing to indicate, for example, that at least a portion of the corresponding components may not be (i) operable, (ii) powered on, (iii) present in the system, and/or (iv) not participating in operation of the system for other reasons.

At interaction 220, a management service request may be provided to network module 160 by management system 102. To generate and provide the management service request to network module 160, management system 102 may (i) obtain information regarding a request for remote management services (e.g., based on a compromised state of hardware resources 150, a request for modification of an application hosted by hardware resources 150, etc.), (ii) receive instruction from the entity tasked with managing data processing system 100A, (iii) transmit the management service request via a message to network module 160, and/or any other processes. By providing the management service request to network module 160, network module 160 may process the management service request to be handled.

At interaction 222, a redirected request may be provided to management controller 152 by network module 160. To provide the redirected to management controller, network module 160 may (i) perform a lookup based on control information (e.g., a source network address, a destination network address, etc.) of the management service request to obtain a lookup result, (ii) determine if the lookup result meets criteria (e.g., a source network address being a network address of management system 102, a destination network address being a network address of hardware resources 150, etc.), (iii) redirecting the management service request to the network addressable endpoint of management controller 152 (e.g., via an out-of-band communication channel), and/or performing any other actions. By providing the management service request to management controller 152, management controller 152 may process the management service request.

To process the management service request, request handling process 224 may be performed. During request handling process 224, the management service request may be screened to identify an action set to perform, and the action set may be performed to place hardware resources 150 in an updated operating state. To screen the management service request, management controller 152 may (i) identify a type of command (e.g., remote wake-up, software install, etc.) indicated by the management service request, (ii) determine whether the command is to be performed by hardware resources 150, and/or perform any other actions to identify the action set to perform based on the management service request.

Once screened, management controller 152 may perform the action set. For example, management controller 152 may (i) perform the command (e.g., repair a compromised portion of hardware resources 150, perform a remote wake-up, etc.), (ii) identify an availability of an operating system hosted by hardware resources 150, (iii) direct the management service request to hardware resources 150, and/or any other processes.

Thus, using processes and interactions shown in FIG. 2B, network communications received from a management system may be redirected to a management controller hosted by a data processing system. By doing so, the management controller may screen the network communications to perform actions to handle a request that may be indicated by the network communications.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIGS. 3A-3C illustrate methods that may be performed by the components of the system of FIGS. 1A-1C. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of processing network communications for operation of a data processing system in accordance with an embodiment is shown. The method may be performed, for example, by any of the components of the system of FIGS. 1A-1C, and/or other components not shown therein.

Prior to operation 300, a consolidated management infrastructure may be established. The consolidated management infrastructure may be established by: (i) providing, by hardware resources of the data processing system, a network addressable endpoint of the hardware resources to the management system, (ii) registering, by the management system, the network addressable endpoint of the hardware resources, (iii) reconfiguring, by a network module of the data processing system, a traffic flow configuration so that communication directed to the hardware resources are redirected to the management controller. Refer to FIG. 3B for additional details regarding establishing a consolidated management infrastructure.

At operation 300, a management service request may be obtained by a management controller of a data processing system. The management service request may be obtained by: (i) obtaining, by the network module, the management service request via a transmission from the management system, (ii) redirecting, by the network module, the management service request to a network addressable endpoint of the management controller, and/or any other processes. Refer to FIG. 3C for additional details regarding processing of network communications from the management system.

At operation 302, the management service request may be screened by the management controller to identify an action set to perform. The management service request may be screened by: (i) analyzing a message (e.g., a payload) to identify a command indicated by the management service request, (ii) comparing the command to a table of commands, (iii) identifying a component of the data processing system to perform the command, and/or any other processes.

At operation 304, performance of the action set may be initiated by the management controller to place the data processing system in an updated operating state. The performance of the action set may be initiated by: (i) executing, by the management controller, at least one command to modify a state of the hardware resources, (ii) directing the management service request to the hardware resources (e.g., via a sideband communication channel), (iii) queuing the management service request to be directed to the hardware resources at a future time (e.g., when an operating system hosted by the hardware resources is available), and/or performing any other actions.

At operation 306, computer-implemented services may be provided by the hardware resources while operating in the updated operating state. The computer-implemented services may be provided by (i) waking up at least a portion of the hardware resources, (ii) pushing updates to a driver and/or a device based on management server request, (iii) modifying access to system resources (e.g., input/output ports, devices, etc.) based on the management server request, and/or any other processes.

The method may end following operation 306.

Using the method shown in FIG. 3A, a quality and/or availability of computer-implemented services provided by a data processing system may be improved by screening management service requests using a management controller of the data processing system.

Turning to FIG. 3B, a flow diagram illustrating a method of establishing a consolidated management infrastructure in accordance with an embodiment is shown. The method may be performed, for example, by any of the components of the system of FIGS. 1A-1C, and/or other components not shown therein.

At operation 310, a network addressable endpoint of the hardware resources may be provided to the management system. The network addressable endpoint of the hardware resources may be provided by: (i) responding to a message and/or broadcast from the management system, (ii) accessing information regarding the network addressable endpoint from storage, (iii) transmitting the information to the management system, and/or any other processes.

At operation 312, a connection notification indicating a connection policy may be obtained by a network module of the data processing system. The connection notification may be obtained by (i) generating, by the management system, a registration confirmation indicating that the network endpoint of the hardware resources is registered to the management system, (ii) generating a preferred network address for the data processing system to use based on the policy of the management schema hosted by the management system, (iii) transmitting a notification (e.g., the registration confirmation or the preferred network address) to the network module via a message, and/or any other processes.

At operation 314, a traffic flow configuration may be reconfigured by the network module based on the connection policy. The traffic flow configuration may be reconfigured by: (i) implementing, by the network module, a communication forwarding policy that may define a network address of the management controller to receive redirected communications, (ii) modifying (e.g., via spoofing) one or more network addresses of interfaces hosted by the network module (e.g., based on a preferred network address provided by the management system), (iii) storing information regarding the connection notification (obtained from the management system) and/or the communication forwarding policy in a cache hosted by the management controller, (iv) applying connection configurations to establish a network connection between the data processing system and the management system (e.g., by resetting the one or more interfaces hosted by the network module), and/or any other processes.

The method may end following operation 314.

Using the method shown in FIG. 3B, a consolidated management infrastructure maybe established that may be used by the data processing system to process communications received from the management system.

Turning to FIG. 3C, a flow diagram illustrating a method of processing network communications by a data processing system and from the management system in accordance with an embodiment is shown. The method may be performed, for example, by any of the components of the system of FIGS. 1A-1C, and/or other components not shown therein.

At operation 320, the management service request may be obtained by the network module. The management service request may be obtained by: (i) monitoring by the management system, a state of the data processing system, (ii) prompting the management system for a modification to an operating state of the data processing system (iii) receiving instruction from the entity tasked with managing the data processing system, (iii) receiving the management service request via a message from the management system, and/or any other processes At operation 322, a lookup may be performed by the network module based on control information of the management service request to obtain a lookup result. The lookup may be performed by: (i) analyzing a message including the management service request to identify information regarding a source address and a destination network address, (ii) comparing the information to a lookup table that may indicate actions to perform based on the information, and/or any other processes.

At operation 324, a determination may be made regarding whether the lookup result meets criteria. The determination may be made by: (i) comparing the lookup result to a list of defined network addresses, (ii) identifying that control information of the management service request includes a destination network address being a network addressable endpoint of the hardware resources, (iii) identifying that control information of the management service request includes a source network address being a network addressable endpoint of the management system, and/or performing any other actions. If the lookup result meets criteria (e.g., the determination is “Yes” at operation 324), then the method may proceed to operation 326. If the lookup result does not meet criteria (e.g., the determination is “No” at operation 324), then the method may end following operation 324.

At operation 326, the management service request may be redirected to the management controller by the network module. The management service request may be redirected by: (i) directing the management service request to a network addressable endpoint of the management controller (e.g., via an out-of-band communication channel), (ii) preventing the management service request from reaching the hardware resources, (iii) repackaging one ore more message regarding the management service request, and/or any other processes.

The method may end following operation 326.

Thus, using the methods shown in FIGS. 3A-3C, a data processing system may process network communications related to managing the data processing system by redirecting the network communications to a management controller of the data processing system. By doing so, the management controller may perform actions to update operation of the data processing system that may improve a quality of computer-implemented services provided by the data processing system.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of processing network communications for operation of a data processing system, the method comprising:
obtaining, by a management controller of the data processing system, a management service request:
from a management system tasked with remotely managing operation of the data processing system,
directed to hardware resources of the data processing system, and
redirected, by a network module of the data processing system, to the management controller;
screening, by the management controller, the management service request to identify an action set to perform;
initiating, by the management controller, performance of the action set to place the hardware resources in an updated operating state; and
providing, by the hardware resources, computer-implemented services while operating in the updated operating state.

2. The method of claim 1, further comprising:
prior to obtaining the management service request by the management controller:
obtaining, by the network module, the management service request;
performing, by the network module, a lookup based on control information of the management service request to obtain a lookup result, the control information comprising a source network address and a destination network address;
making a determination regarding whether the lookup result meets criteria; and
in an instance where the lookup result meets the criteria:
redirecting, by the network module, the management service request to the management controller.

3. The method of claim 2, wherein the criteria comprises:
a source network address being a network addressable endpoint of the management
system; and
a destination network address being a network addressable endpoint of the hardware resources.

4. The method of claim 1, further comprising:
prior to obtaining the management service request:
establishing a consolidated management infrastructure between the management system and management components of the data processing system, the management components comprising the management controller and the hardware resources.

5. The method of claim 4, wherein establishing the consolidated management infrastructure comprises:
providing, by the hardware resources, a network addressable endpoint of the hardware resources to the management system;
obtaining, by a network module of the data processing system, a connection notification from the management system indicating a connection policy; and
reconfiguring, by the network module, a traffic flow configuration based on the connection policy so that communication directed to the hardware resources are redirected to the management controller.

6. The method of claim 5, wherein the network addressable endpoint comprises a media access control (MAC) address.

7. The method of claim 6, wherein the connection policy comprises one MAC address from a group consisting of:
the network addressable endpoint of the hardware resources; and
a preferred MAC address provided by the management system.

8. The method of claim 1, wherein screening the management service request comprises:
identifying a type of command indicated by the management service request; and
making a determination regarding whether the command is to be performed by the hardware resources.

9. The method of claim 8, wherein the action set comprises at least one action from a group of actions consisting of:
performing, by the management controller, the command;
identifying an availability of an operating system hosted by the hardware resources;
in a first instance of the identifying where the operating system is available:
directing the management service request to the hardware resources; and
in a second instance of the identifying where the operating system is not available:
queuing the management service request to be directed to the hardware resources at a future time.

10. The method of claim 1, wherein the data processing system comprises hardware resources and a network module adapted to separately advertise network endpoints for the management controller and the hardware resources of the data processing system, the network endpoints being usable by a remote entity to address communications to the hardware resources using an in-band communication channel and the management controller using an out-of-band communication channel.

11. The method of claim 10, wherein the management controller and the network module are on separate power domains from the hardware resources so that the management controller and the network module are operable while the hardware resources are inoperable.

12. The method of claim 10, wherein the out-of-band communication channel runs through the network module, and an in-band communication channel that services the hardware resources also runs through the network module.

13. The method of claim 10, wherein the network module hosts a transmission control protocol/internet protocol (TCP/IP) stack to facilitate network communications via the out-of-band communication channel.

14. A non-transitory machine-readable medium having instructions stored therein, which when executed by a processor, cause the processor to perform operations for processing network communications for operation of a data processing system, the operations comprising:
obtaining, by a management controller of the data processing system, a management service request:
from a management system tasked with remotely managing operation of the data processing system,
directed to hardware resources of the data processing system, and
redirected, by a network module of the data processing system, to the management controller;
screening, by the management controller, the management service request to identify an
action set to perform;
initiating, by the management controller, performance of the action set to place the hardware resources in an updated operating state; and
providing, by the hardware resources, computer-implemented services while operating in the updated operating state.

15. A non-transitory machine-readable medium of claim 14, wherein the operations further comprise:
prior to obtaining the management service request by the management controller:
obtaining, by the network module, the management service request;
performing, by the network module, a lookup based on control information of the management service request to obtain a lookup result, the control information comprising a source network address and a destination network address;
making a determination regarding whether the lookup result meets criteria; and
in an instance where the lookup result meets the criteria:
redirecting, by the network module, the management service request to the management controller.

16. A non-transitory machine-readable medium of claim 15, wherein the criteria comprises:
a source network address being a network addressable endpoint of the management system; and
a destination network address being a network addressable endpoint of the hardware resources.

17. A non-transitory machine-readable medium of claim 14, wherein the operations further comprise:
prior to obtaining the management service request:
establishing a consolidated management infrastructure between the management system and management components of the data processing system, the management components comprising the management controller and the hardware resources.

18. A data processing system, comprising:
a processor; and
a memory coupled to the processor to store instructions, which when executed by the processor, cause the processor to perform operations for processing network communications for operation of the data processing system, the operations comprising:
obtaining, by a management controller of the data processing system, a management service request:
from a management system tasked with remotely managing operation of the data processing system,
directed to hardware resources of the data processing system, and
redirected, by a network module of the data processing system, to the management controller;
screening, by the management controller, the management service request to identify an action set to perform;
initiating, by the management controller, performance of the action set to place the hardware resources in an updated operating state; and
providing, by the hardware resources, computer-implemented services while operating in the updated operating state.

19. The data processing system of claim 18, wherein the operations further comprise:
prior to obtaining the management service request by the management controller:
obtaining, by the network module, the management service request;
performing, by the network module, a lookup based on control information of the management service request to obtain a lookup result, the control information comprising a source network address and a destination network address;
making a determination regarding whether the lookup result meets criteria; and
in an instance where the lookup result meets the criteria:
redirecting, by the network module, the management service request to the management controller.

20. The data processing system of claim 19, wherein the criteria comprises:
a source network address being a network addressable endpoint of the management system; and
a destination network address being a network addressable endpoint of the hardware resources.
